(19) United States
(12) Patent Application Publication
(10) Pub. No.: US 2004/0251848 A1
(43) Pub. Date: Dec. 16, 2004

(54) Electronic switch for lighting lamp that has security function

(76) Inventor: Jihn-Kuk Kim, Seoul (KR)

Correspondence Address: Jonathan Y Kang, Lee Hong Degerman Kang & Schmadeka, 14th Floor, 801 South Figueroa Street, Los Angeles, CA, 90017-5564, US

(21) Appl. No.: 10/494,856

(22) PCT Filed: Nov. 6, 2002
(86) PCT No.: PCT/KR02/02070

(30) Foreign Application Priority Data
Nov. 6, 2001 (KR) 2001/69015

(51) Int. Cl. H05B 37/02

(52) U.S. Cl. 315/209 R

(57) ABSTRACT

This is about the method for performing security function of wall mounted use electric switch and the Switch itself. The invented product comprising Control Micom [U1] in the Switch, luminance sensor, On/Off Key [SW1] and security Key [SW2], operates 24 hr clock based on the outside luminance detected by CDS. The Switch turns off lamps during daytime and turns on lamps during specific night times according to the on/off Timer Program [S108] loaded in the Micom [U1], when the security mode is set on by the users one touch key [SW2], the switch turns on and off lamps according to the users on/off key [SW1], when the security mode is not set. Because users can operate the security Function without a clock setting or time schedules, it is convenient to use. And, because lamps are turned off during the daytime, power consumption is also reduced.

### TECHNICAL FIELDS

The invention introduction is “the method of performing the security Function of the Switch and the Switch itself” [hereinafter, “The Switch”]. The Switch can substitute the existing mechanic switch, of which the sole function is to turn on and off Lamps, and has a one-touch security Function. Normally, night thieves watch for houses where lamps are turned off. Therefore, turning lamps on in the early evening can prevent thieves. When leaving home for a long time or when you expect to come home late, use the security Function.

### BACKGROUND ART

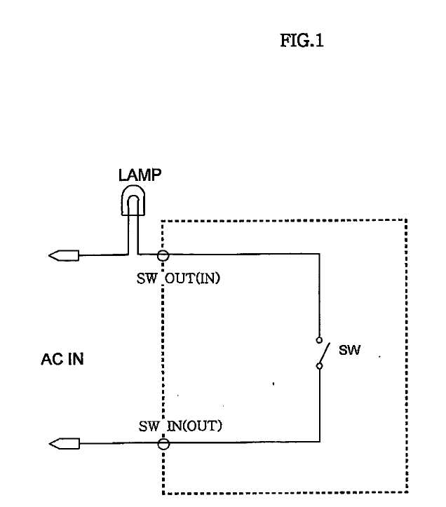

As shown by <FIG. 1>, if you turn the Switch on for 24 hours, it needs much electric power, and thieves may look for houses where Lamps are turned on 24 hours a day. If using The Switch equipped with clock functions to turn on Lamps at scheduled times only, it is necessary to adjust time and schedules again after power failures.

### DISCLOSURE OF INVENTION

With the help of this invention, “users of the Switch” (hereinafter, “Users”) can easily operate “the security Function of The Switch” using the one-touch function.

Another purpose of this invention is to provide “The Switch” which has normal on-off functions and security Function.

The features of The Switch are that, if the security Function is set on, the security Function status is shown by its LED lamp and with the luminance sensor [CDS] distinguishes day time and night time. It turns lamps off during day time and turns Lamps on for four or five hours in the evening after sunset and turns them on again in the early morning before sunset only, for one or two hours. The product has an on-off key to turn Lamps on or off, a security Function key, a LED lamp and a light sensor to distinguish night and day, and to operate a 24 hour clock in itself.

Therefore, users can easily turn the Lamps on or off, and set security status using its one touch function.

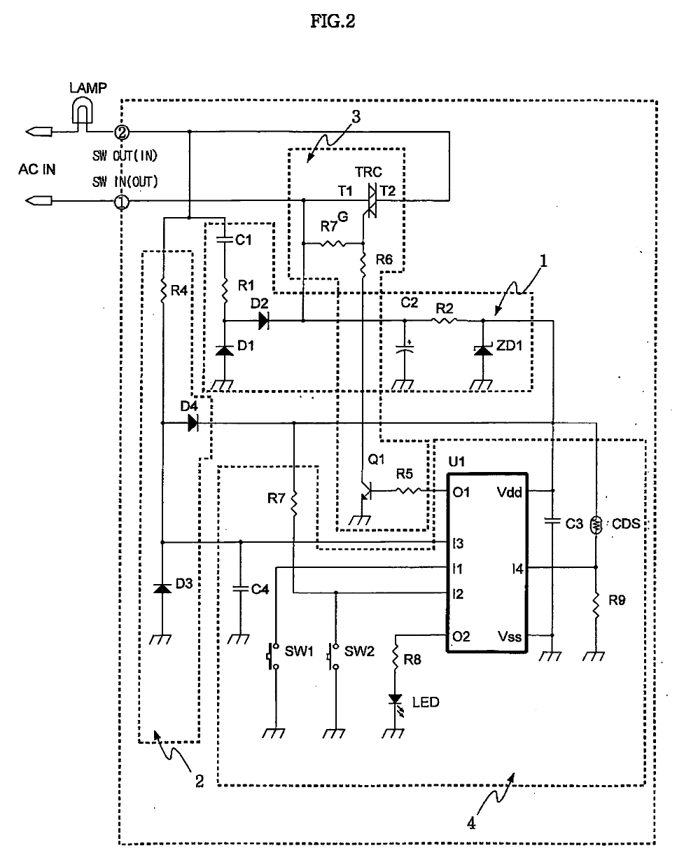

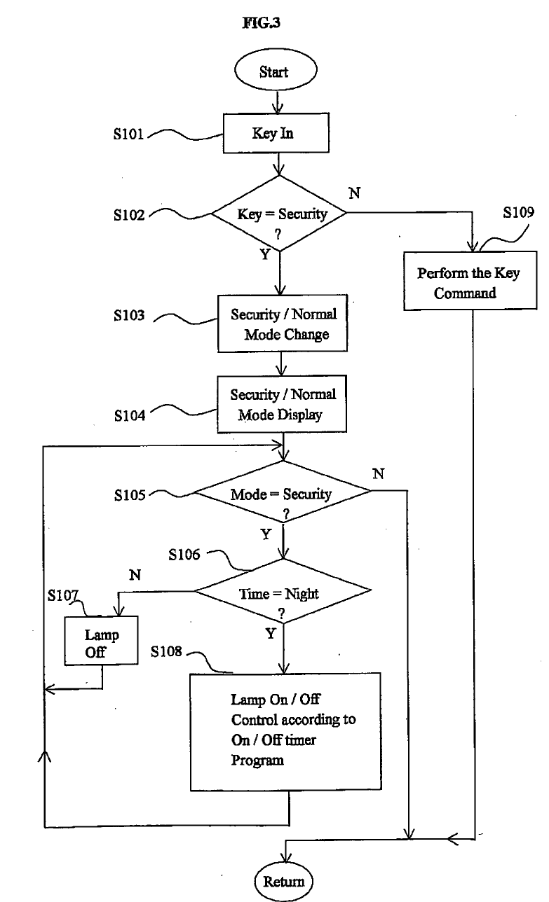

Refer to attached drawings for detailed practical and desirable usages. <FIG. 1> shows a normal wall Switch, and <FIG. 2> is the circuit configuration of the Switch adopting this invention. Terminal \mathring{1} and \mathring{2} in <FIG. 2> link switch lines on walls. Drawing mark 1 is the driving power circuit block of the Switch, and Drawing mark 2 is a circuit block to detect the phase of AC input. Drawing mark 3 is Triac [TRC] and its driving circuit block to switch Lamps, and Drawing mark 4 is a control Micom and its surround circuit block, which controls the operation of the Switch. The terminal O1 and O2 of Micom are output terminals, and I1˜I4 are input terminals. When No. 1 output [O1] is Logic 1 [High], Triac [TRC] is turned On to turn on Lamp, and when No. 1 output [O1] is Logic 0 [Low], Triac [TRC] is turned Off to turn off Lamp. The fourth input terminal [I4] of Micom [U1] is an analog input terminal to detect luminance, and No. 1 and No. 2 input terminals [I1˜I2] are Key input terminals. If No. 2 output [O2] is high, LED turns on and the Security Mode is set. And No. 2 output [O2] is low, LED turns off and the security mode is changed to normal mode. Pushing SW2 makes the setting status change. Under Normal Mode, SW1 is used to turn the Lamp on or off, and, Micom[U1] detects luminance to operate its 24 hr clock, and controls the Lamp using its on-off timer program. Micom[U1] sets A.M. 12:00 as a central point between dawn and early evening, and sets P.M. 12:00 as a central point between early evening and dawn to operate the 24 hr clock. Under Security Mode, the Lamp is on for four or five hours during the evening, once or twice for brief times around midnight, and for one or two hours during the early morning. <FIG. 3> is the Flow Chart of the Switch showing the method for performing the unique security function of this invention.

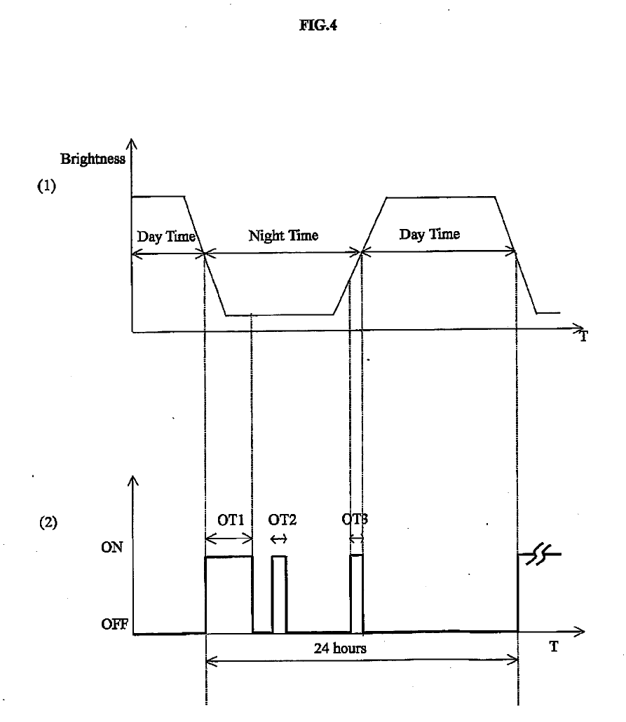

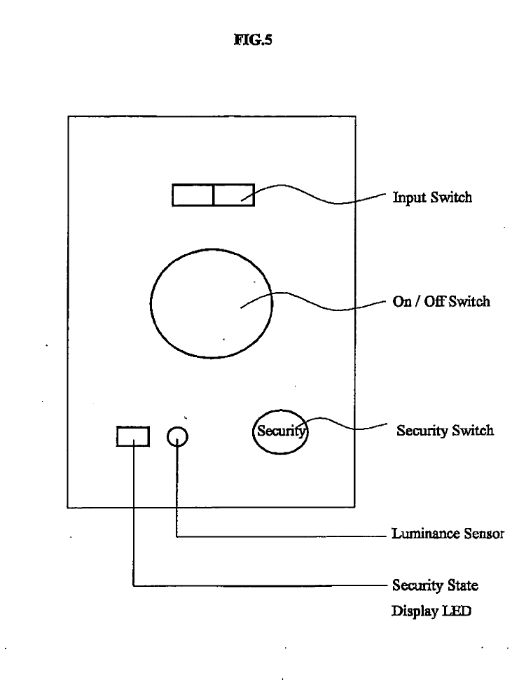

When a key is inputted [S101], whether the key is security key or not is determined [S102]. If it is not the Security Mode key, then appropriate orders are performed. If it is Security Mode key, Mode is changed from Security to Normal or Normal to Security [S103], and then changed status is shown [S104]. If the status is Normal Mode, then waiting for another key input, regarding given orders have been completely performed. If the changed status is Security Mode, Micom determines whether it is day or night using the 24 hr clock [S106]. If it is daytime, it turns the tamps off [S107], and checks Security or Normal Modes [S105]. If it is nighttime, the Lamp is controlled by the On/off Timer Program in U1 [S108], and Security or Normal Modes are checked [S105].

<FIG. 4>(1) shows that Micom[U1] detects luminance using CDS to determine whether it is day or night, and <FIG. 4> (2) shows output Timing Drawing when adopted this security Function. <FIG. 5> shows one of the exterior view of the Switch.

As described above, using the Switch, Users can easily operate the security Function using the one touch button. The function is operated by the 24 hr clock, made by determing daytime and night time using luminance sensor and the On-Off Timer Program in U1. Because, the Switch itself determines when to turn the Lamps on or off automatically and turn the lamps off in day time this invention gives energy saving effect and convineance to the user of the switch.

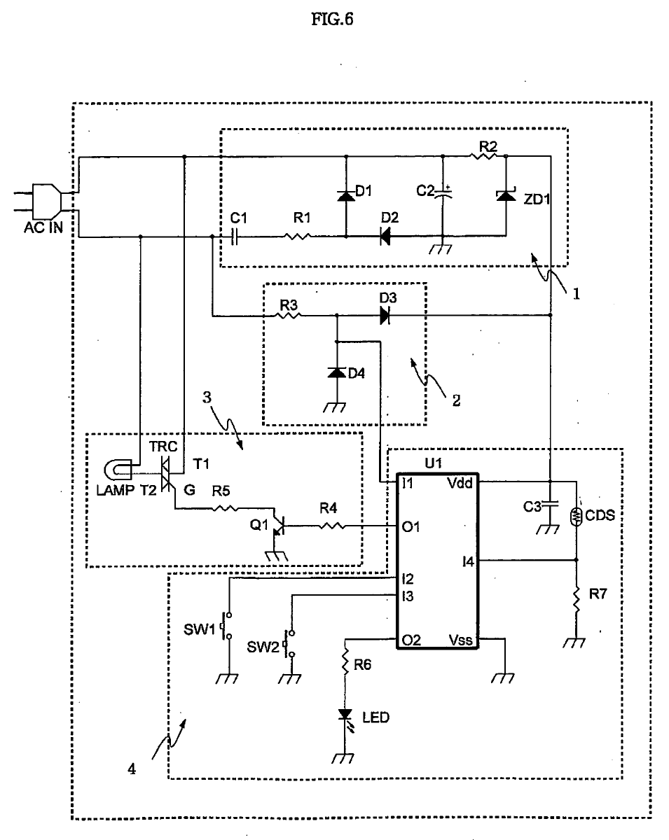

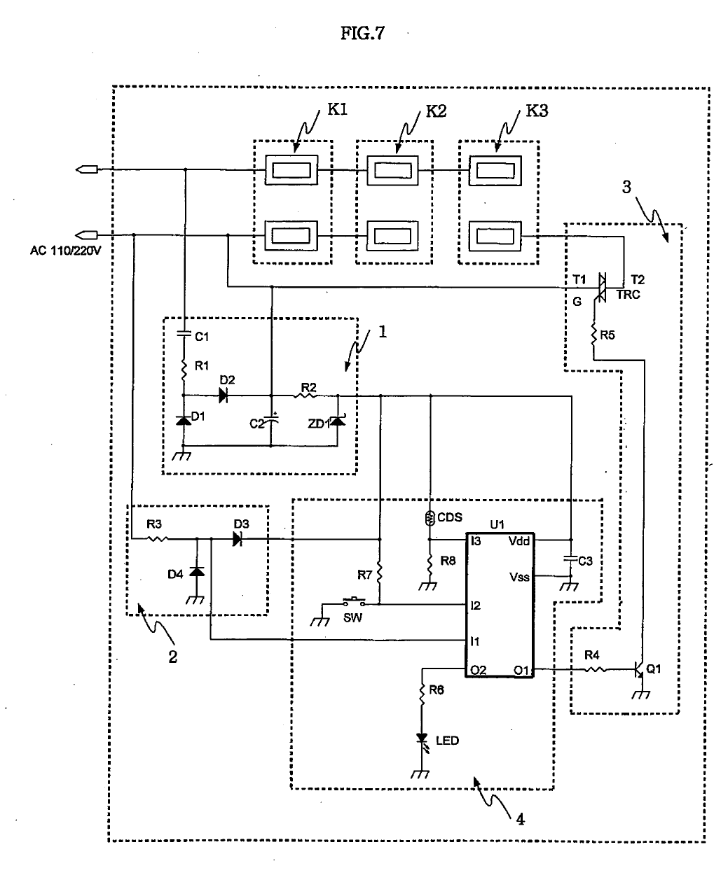

### BRIEF DESCRIPTION OF DRAWINGS

<FIG. 1> One of the circuit configuration of normal switches.

<FIG. 2> One of the circuit configuration of the Switch of this invention.

<FIG. 3> The Flow Chart of the method for performing security function of this invention.

<FIG. 4> One of the Timing Drawing of the Switch how to control Lamps when performing the security mode.

<FIG. 5> One of the external view of the Switch.

<FIG. 6> One of the circuit configuration of electric stands when the Switch is applied to them.

<FIG. 7> One of the circuit configuration of electric outlets when the Switch is applied to them.

### DESCRIPTION ABOUT SYMBOLIC MARKS OF THE SWITCH DRAWING

AC In; alternating current Input

Lamp; lighting lamp

SW In [Out]; Switch Input [Output] Terminal

SW Out [In]; Switch Output [Input] Terminal

1; Driving Power Circuit Block

2; AC Input Phase Detection Circuit Block

3; Triac Driving Circuit Block

4; Micom and its Surround Circuit Block

U1; Control Micom

TRC; Triac

G; Gate Terminal of Triac

I1˜14; No.1˜No. 4 Input Terminal of Micom

O1˜O2; No.1˜No. 2 Output Terminal of Micom

SW1; Power [ON.OFF] Switch

SW2; security Switch

LED; Light emitting diode to show security mode

CDS; luminance sensor

VDD; DC (+) Terminal

VSS; DC Earthling Terminal

### BEST MODE FOR CARRYING OUT THE INVENTION

<FIG. 2> show the circuit configuration of the Switch attached to the Wall, <FIG. 6> shows the circuit configuration of the Switch when applied to electric stands, and <FIG. 7> shows the circuit configuration of the Switch when applied to electric outlets.

Though the above examples show some desirable applications, the applications of the invention are not limited to those cases only. The applications of this invention can take various forms, and all these forms are within the application scope of this invention.

What is claimed is:

1. The method for performing security function of wall mounted use electric switch of which the Switch makes a 24 hr clock using its luminance sensor [CDS], to perform a security Function, the security Function is set On by security Key [SW2], the Switch turns the lamp on or off according to On/Off Timer Program [S108] in Control Micom [U1].

2. The electric switch composed by control Micom [U1], luminance sensor [CDS], lamp on/off key [SW1] and security key [SW2], and the switch operates 24 hour clock made by using its luminance sensor, and the switch performs security function according to its on/off timer program loaded in the Micom [U1] when security mode is set and the switch turns on and off lamps by on/off key [SW1] when the security mode is not set.
